(19) United States
(12) Patent Application Publication
(10) Pub. No.: US 2002/0143703 A1
(43) Pub. Date: Oct. 3, 2002

(54) Internet cash card

(76) Inventors: Ahmad Razvan, Blacksburg, VA (US); Behzad Erfani, Vienna, VA (US)

Correspondence Address: THE TECHNOLOGY LAW OFFICES OF VIRGINIA, P.O. Box 818, Middleburg, VA, 20118, US

(21) Appl. No.: 09/819,170

(22) Filed: Mar. 28, 2001

(51) Int. Cl. G06F 17/60

(52) U.S. Cl. 705/44; 705/39; 705/26

(57) ABSTRACT

A new type of cash card which is freely transferable, redeemable and usable and which a user can purchase with a set amount of credit thereon and add to the balance as it is used. The card can be used by the bearer with identification which is handled by a central office. The card can be transferred from one user to another with a registration at the central office

This invention relates to an identity-less cash card which can be purchased and used by anyone, much like cash, to purchase items over the Internet and the user earns interest when he or she is not using the card.

### BACKGROUND

While the Internet has created an ever-growing commerce environment, it requires credit and an established identity with banks and other credit agencies before transactions can take place. This limiting factor resembles a world where cash has no meaning or power. As a large segment of the world's population outside of the major industrialized countries, depend on cash availability in transactions, this limitation on cash, limits commerce for this segment. In certain countries with no credit agency or rating where credit cards are not used, cash is the only medium available for use. One of the problems with cash is that one is wary of carrying large amounts of it around with them and does not want to withdraw too much from banks where it earns interest.

While certain industrialized countries, in particular the United States, have pre-paid credit cards for the population with little or no credit, and certain stores, like Wal-Mart will allow prepayment of balances on in-store cards, there is no universal cash card which ordinary citizens of the world can use as a universal exchange instrument everywhere in place of cash.

The current credit card industry's dominance on purchasing without the need for cash has excluded a large consumer group by limiting their purchasing power. This situation is especially acute on the Internet. Internet commerce relies almost exclusively on the use of secure transactions using the traditional methods of credit payment. For example, American Express, Visa and Master Card dominate the industry. A consumer without a checking account or credit card has no means to purchase goods or services on the net. Needless to say this limitation also applies to senior citizens and perhaps the majority of the world where credit histories and charge cards are not in existence or used.

A recent study by CNN found that “young Americans are more likely to go online; forty-five percent of children, or those under 18, have Internet access. Conversely, the access of those over 65 is only fifteen percent. Neither the young group or the senior group has a large amount of credit, if any. The young simply do not have credit histories, hence no credit cards, and the seniors are living on a low fixed income and do not qualify for credit cards. Consequently, both of these groups are denied access to the Internet but can go and buy anything in a store with cash. Certainly, the Internet is prejudicial in its policy to the purchasing public.

### GENERAL DESCRIPTION

To overcome the problem faced by a large segment of the world's population, both within and without the United States and the rest of the industrialized nations, the subject of this invention, the Internet Cash Card, can be made available. It proposed a business methodology allowing the purchase and deposit of currency on a magnetic card without any accompanying bank account or other depository account. It is similar to cash in all aspects. No identity check is required with the Internet Cash Card and no record ties the owner of the card other than the identification number embossed on the card. The card may be purchased at convenience stores and to use it in lieu of cash and while shopping on the Internet. A unique password accompanies each card which gives added security to the purchaser. If the card is lost, it cannot be redeemed for credit or cash by another without the password.

One of the largest benefits for a business accepting the card is that it is free, there are no credit card company charges to inflate the price offered the consumer and the paperwork the seller faces is reduced.

The card looks like a regular magnetic card but has a unique serial number. A six or more digit password is used for authentication and authorization. There is no account application required of the purchaser of the card and the card itself remains without any identity. There are no restrictions on the user of the card as it is used like cash and can be cashed or used at any time at participating vendors and web sites. It has no maintenance record other than its number.

To market the card, it is sold at a discount to resellers, and stores and business accepting the card are not charged any fee. While the card is designed primarily to be used on the Internet it can be used elsewhere. The security measures built into the card are aimed at securing Internet shopping. Any denominations or loose change can be deposited to the card which allows for a use, finally, for loose change. Store clerks or coin machines can be employed to add to the balance on the card.

The card allows for exchange of monies between individuals which facilitates deposit, transfer and exchange through an Internet site or standard point-of-sale device. The money can be transferred to others through transfer of knowledge of the card serial number. There is no record kept of the transaction other than card numbers and their respective balances and transactions.

When using the card on the Internet, a card authentication is done by entering the card number and the password. The selling facility simply checks the card number, authenticates the password, checks the balances, and then credits the required amount to the purchase.

An account history is available only through the card number. In the case of lost or stolen cards it should be noted that each card has a security number assigned to it at the time of purchase or payment authorization. The cards are designed to be dropped in a mail box if found after being lost (they have the issuing company's address thereon) If a card is lost and not returned within a given period, it will be cancelled and the purchaser of the card must sign off on that condition when he or she purchases the card. If wished, a card can be signed with the name and address of the purchaser so that it can be sent back to the original purchaser if lost and subsequently found. Lost cards, after being found, are generally sent back to the issuer store or bank for possible inquiries. The issuer can then return the card to the owner if the authentication is approved. If there is no security code on file or return address on the card, the card will be sent to the company and destroyed. Funds remaining will be sent to charities as indicated at the time of purchase.

The card is designed to accommodate multiple currencies allowing for the exchange of monies in different currencies at the same time. At the time of usage authorization can be made for transfer in one currency or multiple currencies at the same time.

At the time of issuance, three passwords are assigned, one is an administrative password, the second is a money transfer password and the third is a limited access password. By default, all three passwords are the same but can be changed at the web site ATM-like access system.

For very youthful users/owners, the card's serial number and/or security code is rated so that the user cannot purchase items or services of an adult nature. This rating system is similar to that of the movie industry. Any web site or store accepting the card has to agree to abide by the rating system so that if it sees that the user is only 14 and the purchase is of an adult service, then it will disallow the purchase by not authorizing it. For example, cigarettes cannot be sold to anyone under the age of 18 due to a rating system built into the code.

### OBJECTS OF THE INVENTION

Accordingly, it is an object of this invention to provide a cash card similar in all characteristics to the physical currency for use by population segments which either have no credit, cannot obtain credit or wish to remain anonymous in their purchases.

Another object of this invention is to provide a cash card for youthful purchasers to buy services and objects on the internet while preventing them from purchasing services or objects of an adult nature,

Yet another object of this invention is to provide a cash card which a user can deposit any amount of money thereto at issue or re-issue,

Still another object of the present invention is to provide a cash card which can be transferred from a purchaser to another by simply conveying the card number by entering the transfer onto the issuer's web site,

And still another object of this invention is to provide a cash card which allows for checking the balance by accessing the issuer's web site via ATM machines to determine the current balance,

Another object of this invention is to provide a cash card which can be purchased at any convenience store or bank and the security code issued at that time. The issuer's web site allows for assigning passwords for each authorized transaction providing the means for single use authorization for fixed amount. The passwords can be assigned for authorizing purchases or deposits by third parties. This minimizes the chance of stolen card information or unauthorized purchases or deposits. This also reduces the chance of depositing into a wrong account. Generally, three passwords are assigned, an administrative password, money transfer password and a limited access password.

Another object of this invention is to provide a cash card which allows the owner to earn interest while in possession of the card,

A final object of this invention is to protect the user's privacy and the cardholholder information is not saved anywhere and his anonymity is maximized.

Additional objects of this invention are to provide a cash card which allows for storing credit electronically thereon in multiple currencies, are unusable if lost due to a personal security password, and which can be used in direct exchanges by transferring credit from one cards owner to another card's owner by the use of a clearing agent web system on ATM-like systems.

These and other objects will become apparent when reference is had to the accompanying drawings in which

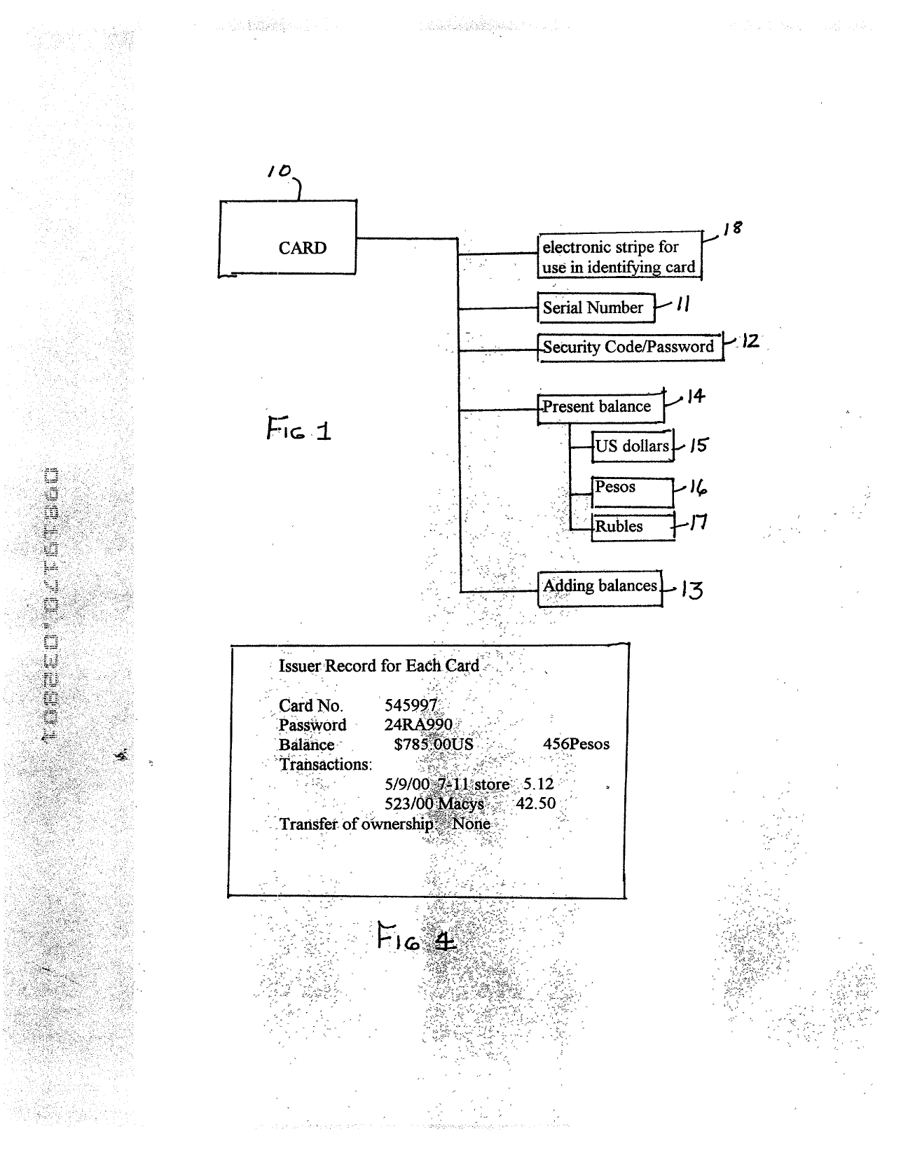

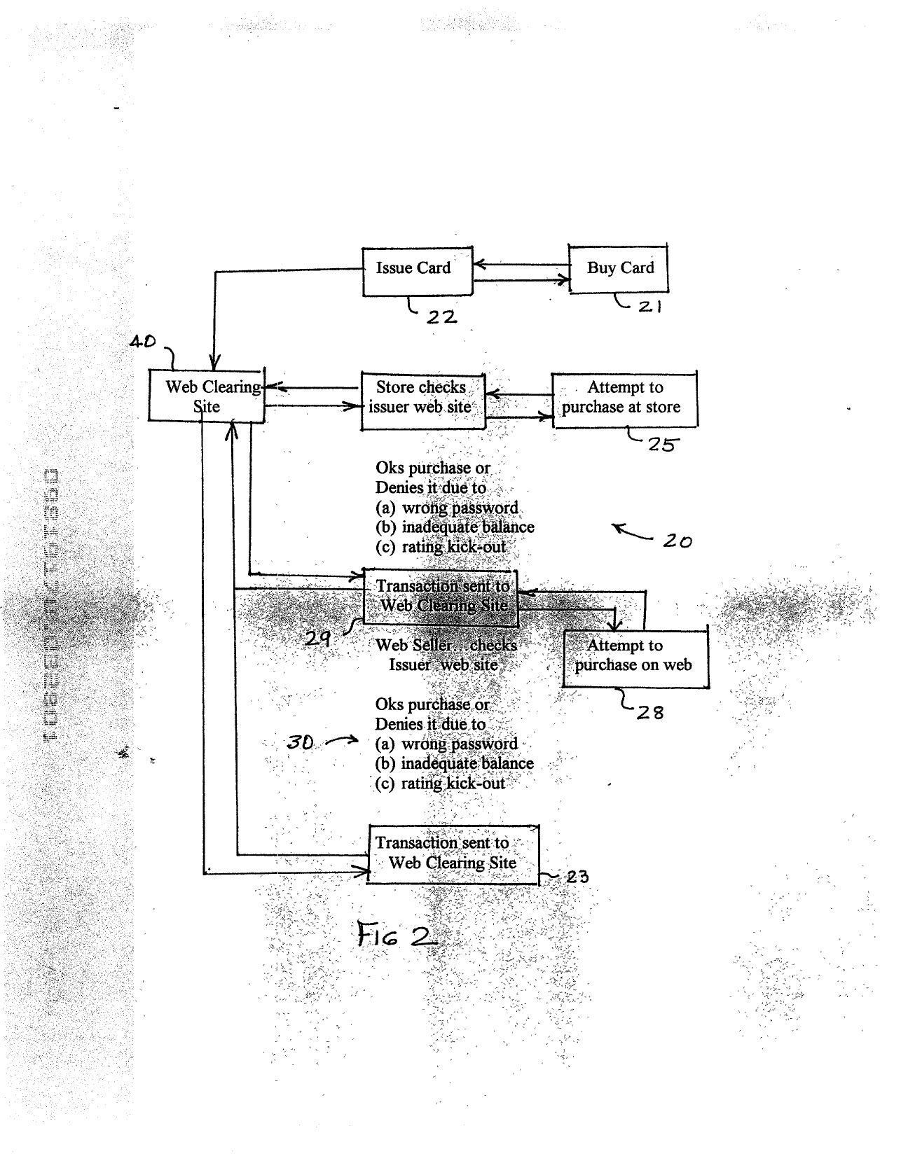

FIG. 1 is a block diagram of the card with its features.

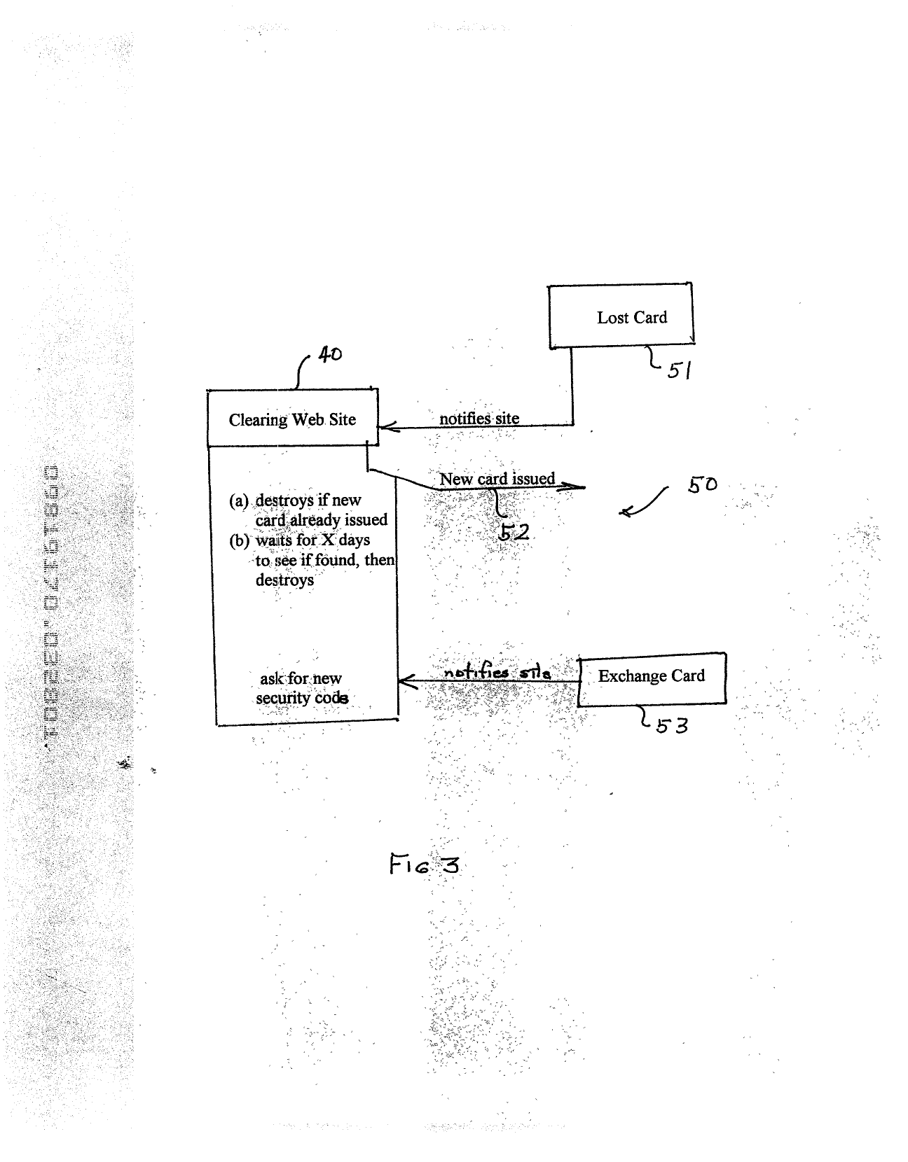

FIG. 2 is a diagrammatic flow chart of the business method used in the instant invention and the various features of the card.

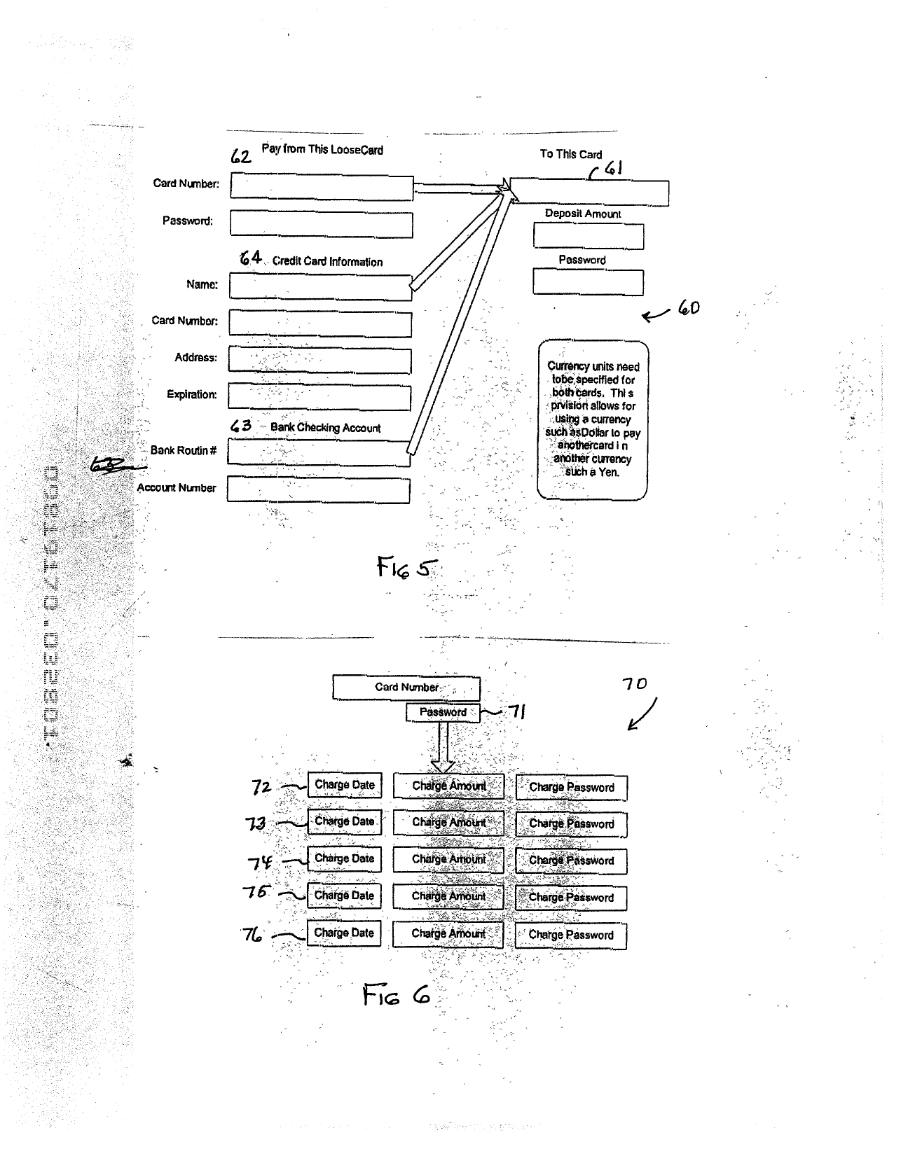

FIG. 3 is diagrammatic view of the business flow when the card is either lost or transferred.

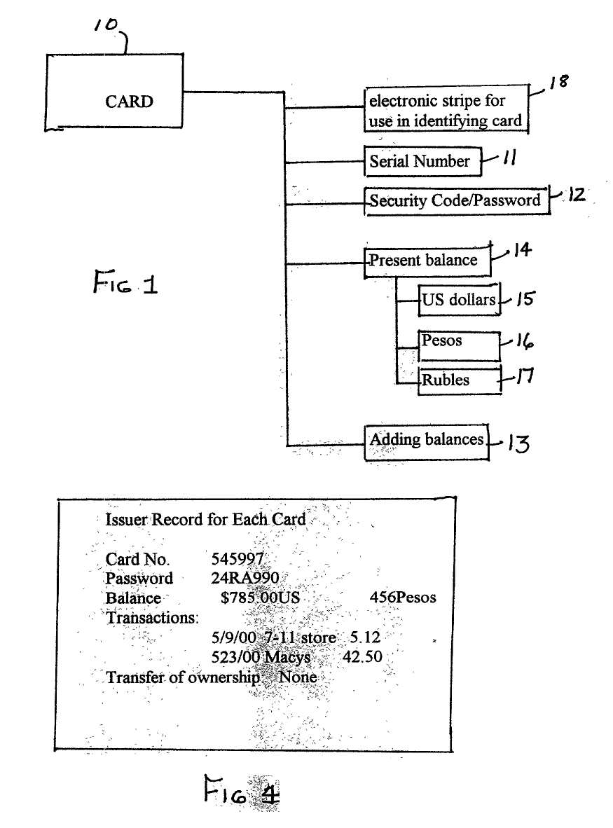

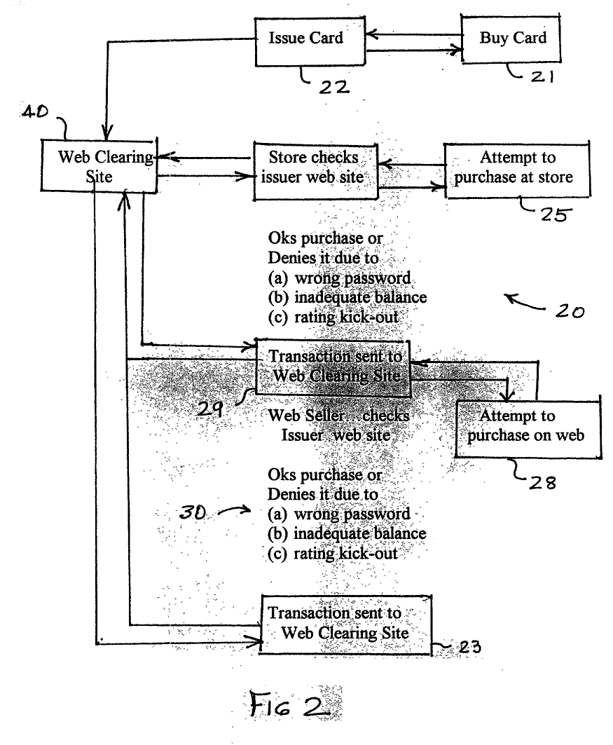

FIG. 4 is a representation of the issuer or issuer clearing agent's records pertaining to each card issued.

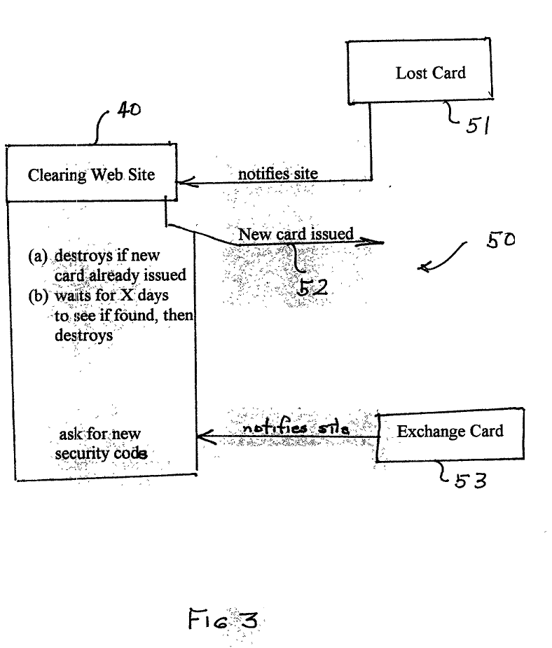

FIG. 5 is a diagrammatic view of how monies are transferred to the card using different systems.

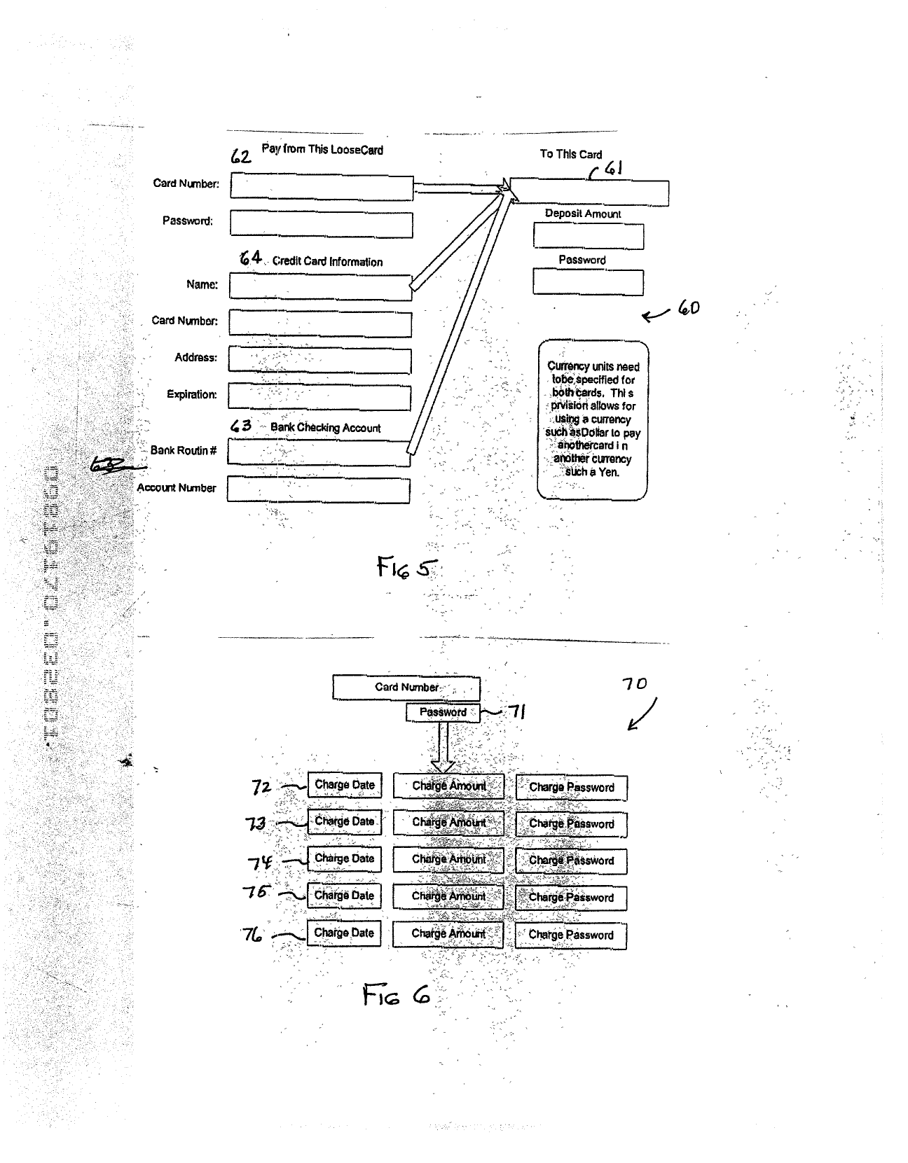

FIG. 6 is is a diagrammatic view of how assignment of purchase/deposit passwords are made.

Referring now to FIG. 1 there is shown a card 10 which has the features of a unique serial number 11, a security code password, 12, and an add to balance feature 13. In addition, there is a present balance feature 14 which can accommodate multiple currencies such U.S. dollars 15, Pesos 16 or Rubles 17. If the user wishes to use the card, say at a gas pump where there is an electronic register and a keypad, he or she will use the electronic strip feature 18 which will register the card initially with the stations contact with the web clearing agent and the owner will key in his or her code on the keypad.

FIG. 2 shows the process 20 for obtaining and using the card which forms the basis for the present invention. The user A purchases a card as at 21 and the information by the issuing store or bank goes to the clearing agent web site 40 and a record of the card serial number and password code 23 is kept and the card issued as at 22.

The user A then decides to purchase an item in a store 25 which checks the card by swiping the card through the electronic register which then communicates the serial number to the clearing agent website 40. The card owner then keys in the password him or herself, to avoid giving the number to the store employee, and that, in turn, is passed to the site 40. The transaction is either approved or denied for one of three reasons, (1) the security code is not legitimate, the balance on the card is inadequate, or there is a minor involved and the rating system built into the code will not allow the purchase to be consummated.

It should be noted that the electronic balance can either be kept in the card electronically so that swiping it automatically denotes the balance or it can be kept at the clearing agent's location or both.

The user A then attempts a purchase over the Internet as at 28. The security code and the serial number of the card in this instance must be typed in on the keypad and the Internet seller 29 will contact the clearing house website to determine if there is sufficient balance, the password is authenticated and the rating system does not note that the transaction is unauthorized under the rating system. The process 30 is accomplished and the balance is deducted to the amount of the sale. It should be noted that unless a card swipe is involved, this type of transaction does not involve changing the balance on the card itself electronically as there is no electronic connection. All the deduction goes on at the site 40 where the subtraction is made.

FIG. 3 shows the process 50 for clearing a lost card 51. The holder notifies the clearing web site 40 which then can issue a new card as at 52. It will destroy a card that has subsequently been found and turned in is the new card 52 has already been issued. It waits for several days before destroying the old card. When one wishes to exhange a card as at 53 the clearing web site merely asks for a new security code before exchanging it.

FIG. 4 shows the clearing agents records which has a card identified by serial number, the authorizing password code, the current balance and the country currency, a list of transactions and any transfer of ownership that may have occurred. All that appears are identifying, numbers, no names or addresses. This is basically an electronic cash system which utilizes the internet as a clearing house.

Referring now to FIG. 5 there is shown the diagram for the transfer of monies To the card using a system. There is shown system 60 where a cardholder can assign fixed charge or deposit passwords only to be used for a single transaction. The password will expire after a single purchase or deposit. The added security allows for controlling of deposits in the account by third parties as well as minimizing the chance of fraud in case a card account number is lost or stolen. Monies can be transferred to the card 61 from another card as at 62, from a checking account as at 63 or from a credit card as at 64. Obviously, currency units need to be specified for both cards.

Referring now to FIG. 6 there is shown a diagram 70 which shows that the cardholder can assign fixed charge or deposit passwords only to be used for a single transaction. The password 71 will expire after a single purchase or deposit. The added security this brings allows for controlling of deposits in the account by third parties as well as minimizing the chance of fraud in case a card account number is stolen or lost. The assigned passwords expire after a single use. If dates are specified, the password expires after the stated date as at 71 through 76. This feature increases the security on the account while maintaining the privacy of the cardholder. Each charge/deposit amount requires the selection of the currency unit.

While only one embodiment of this invention has been shown and described, it will become obvious to those of ordinary skill in the art that many changes and modifications can be made without departing from the scope of the appended claims in which

1 An electronic cash card system which can be used to purchase services and/or goods at both an internet site and a store, said card comprising.
a central web site for maintaining a record of electronic cash cards, for issuing them and for approving or denying transactions thereon, and for issuing and maintaining a record of balances and additions thereto and subtractions therefrom,
a plurality of electronic cash cards which can be purchased by users, each having a serial number and an authorizing password code, and an Internet connection between issuers of said cards and said central web site for conveying information relative to each card.

2. An electronic cash card system as in claim 1 wherein said cards are capable of being purchased in multiple currencies and of maintaining balances in said multiple currencies.

3 An electronic cash card system as in claim 1 wherein said electronic cash card system has a minor rating built into the password or the serial number of each card, the rating designed to disallow transactions that involve purchase of goods or services for adults only.

4. An electronic cash card system as in claim 1 wherein the electronic system cards have the same name and address of either the issuer or owner thereon so that when lost they can be mailed back to the issuer or owner.

5. An electronic cash card system as in claim 1 wherein increases to the present balances of said cards can be made at any time by stores or vendors participating in the program by simply receiving additional funds and notifying the clearing house web site of the additional funds which are then added to the present balance.

6. An electronic cash card system as in claim 1 wherein the central web site maintains a record of each card, its serial number, its password code, a history of all transactions and the outstanding balances thereon in each currency of choice.

7. An electronic cash card system as in claim 6 wherein said central web site is able to deduct and add amounts to each said balance in each said currency.

8. An electronic cash card system as in claim 1 wherein each said card has an electronic stripe for automatically notifying the central web site or store or Internet seller of the outstanding balance on the card.

9. An electronic cash card system as in claim 8 wherein the central web site automatically, through the interaction of the electronic swipe, can increase or decrease the amount of the balance of the card.

10. An electronic cash card for use in purchasing goods or services from stores and/or over the Internet, said card comprising
a card with a serial number,
a password accompanying said card for entering into a central web site via a keypad or phone when the owner of said card is purchasing an item.
whereby said central web site acts as a clearing agent for said card whenever a purchase is made.

11. An electronic cash card as in claim 10 wherein said card has an electronic stripe thereon, said stripe acting to notify the central web site of the balance in said card when said card is swiped through an electronic card slot at a participating seller.

12. An electronic cash card as in claim 10 wherein said card has a rating system built into it and designed to prevent minor holders of said card from purchasing adults-only goods or services.

13. An electronic cash card as in claim 10 wherein the said card is capable of registering with said central web different balances in different currencies.

14. An electronic cash card as in claim 10 and including the name and address either the issuer or the purchaser so that when the card is lost it may be mailed to either.

15. An electronic cash card as in claim 10 wherein balances from either a credit card, a checking account or other source of finds may be transferred to said card.

16 An electronic (ash card as in claim 10 wherein a designated portion of the balance of each card may be preselected to be used by a given date and not after that.

17. An electronic cash card as in claim 10 wherein only certain predetermined balances in each card may be used by a preselected date.

18 An electronic cash card as in claim 10 which has mulitiple passwords.

19. An electronic cash card as in claim 18 wherein one of said multiple passwords is for balance transfers to said card.

20. An electronic cash card as in claim 18 wherein one of said multiple passwords is for use in purchases.
